(19) United States
(12) Patent Application Publication
(10) Pub. No.: US 2022/0036125 A1
(43) Pub. Date: Feb. 3, 2022

(54) TARGET DATA FEATURE EXTRACTION METHOD AND DEVICE

(71) Applicant: Xiamen SigmaStar Technology Ltd., Fujian (CN)

(72) Inventor: ZiCheng YAN, Shanghai (CN)

(21) Appl. No.: 17/341,714

(22) Filed: Jun. 8, 2021

(30) Foreign Application Priority Data
Jul. 31, 2020 (CN) 202010761747.4

(51) Int. Cl. G06K 9/62; G06N 3/04; G06N 3/08

(52) U.S. Cl. CPC G06K 9/6232; G06K 9/6261; G06N 3/08; G06N 3/0481; G06K 9/6289

(57) ABSTRACT

In a target data feature extraction method, a feature vector of target data is extracted, initial unit data and initial hidden data of a predetermined neural network are determined, and the feature vector, initial unit data and initial hidden data are inputted to the predetermined neural network for processing to update unit data and hidden data of the predetermined neural network, and the updated hidden data are stored. The updated unit data and hidden data are again inputted to the predetermined neural network for processing, recursive processing of the update is performed for predetermined processing times, and the updated hidden data after update each time are stored. Multiple sets of hidden data stored after the predetermined processing times are merged, and outputted as a target data feature. The application can achieve extraction of target data features in an LSTM network by a single deduction method.

This application claims the benefit of China application Serial No. 202010761747.4, filed on Jul. 31, 2020, the subject matter of which is incorporated herein by reference.

### BACKGROUND OF THE INVENTION

### Field of the Invention

The invention relates to the field of data processing, and more particularly to a target data feature extraction method and device.

### Description of the Related Art

The function of image features is for describing image information, and image features in the physical aspect generally include shapes, colors, textures and spatial relationship. Image feature extraction using convolutional neural networks is commonly applied, and achieves good results. For example, convolutional neural networks includes recurrent neural networks (RNN), long short-term memory (LSTM) networks and gated recurrent units (GRU), wherein the LSTM having a long-term memory function is mostly extensively applied.

In natural language processing, the LSTM network particularly excels in sequence related tasks, such as dialog systems, machine translation and image description. One module having a recursive structure in fact may be split into combinations having the same sub structures, and an output of a previous stage acts as an input of a current stage.

A conventional LSTM network is frequently structured based on convolutional architecture for fast feature embedding (Caffe), and involves extensive operations and a complex network structure. Therefore, there is a need for a solution for optimizing such network structure and simplifying operation steps.

### SUMMARY OF THE INVENTION

The present invention provides a target data feature extraction and method achieving target data feature extraction in an LSTM network by means of a single deduction method.

To solve the technical issues above, a target data feature extraction method is provided as a technical solution according to an embodiment of the present invention. The method includes: extracting a feature vector of target data; determining initial unit data and initial hidden data of a predetermined neural network, inputting the feature vector, the initial unit data and the initial hidden data to the predetermined neural network for processing so as to update unit data and hidden data of the predetermined neural network, and storing the updated hidden data; and inputting again the updated unit data and the hidden data to the predetermined neural network for processing to update again the unit data and the hidden data, performing recursive processing of the update for predetermined processing times, and storing the hidden data after the update each time; and merging and outputting a plurality of sets of hidden data stored after the predetermined processing times as a target data feature.

The present invention further provides a target data feature extraction device comprising an extraction unit, a processing unit, an update unit, and an output unit. The extraction unit extracts a feature vector of target data. The processing unit determines initial unit data and initial hidden data of a predetermined neural network, inputs the feature vector, the initial unit data and the initial hidden data to the predetermined neural network for processing so as to update unit data and hidden data of the predetermined neural network, and stores updated hidden data. The update unit inputs again the updated unit data and the hidden data to the predetermined neural network for processing so as to update again the unit data and the hidden data, performs recursive processing of the update for predetermined processing times, and stores hidden data after the update each time. The output unit merges and outputs a plurality of sets of hidden data stored after the predetermined processing times, as a target data feature.

The embodiments of the present application can achieve extraction of target data features in an LSTM network by means of a single deduction method, thereby applying the LSTM network on different structures and enhancing diversity.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a flowchart of a target data feature extraction method provided according to an embodiment of the present invention;

FIG. 2 is a structural schematic diagram of a long short-term memory (LSTM) network unit provided according to an embodiment of the present invention;

FIG. 3 is another flowchart of a target data feature extraction method provided according to an embodiment of the present invention;

FIG. 4 is a structural schematic diagram of a fully connected layer provided according to an embodiment of the present invention;

FIG. 5 is a structural schematic diagram of a target data feature extraction device provided according to an embodiment of the present invention; and

FIG. 6 is another structural schematic diagram of a target data feature extraction device provided according to an embodiment of the present invention.

### DETAILED DESCRIPTION OF THE INVENTION

The technical solutions in the embodiments of the present invention are clearly and comprehensively described with the accompanying drawings of the embodiments of the present invention below. It is obvious that the embodiments described are merely some but not all possible implementations of the present invention. On the basis of the embodiments of the present invention, all other embodiments arrived by a person skilled in the art without involving inventive skills are to be encompassed within the scope of protection of the present invention.

The term “embodiment” throughout the literature implies that specific features, structures or characteristics described in combination with the embodiments may be included in at least one embodiment of the present invention. The term appearing in different parts of the description does not necessarily refer to the same embodiment, or an independent or alternative embodiment exclusive from other embodiments. It can be explicitly and implicitly understood by a person skilled in the art that the embodiments described in the literature may be combined with other embodiments.

A target data feature extraction method is provided according to an embodiment of the present invention. An execution entity of the target data feature extraction method may be a target data feature extraction device provided according to an embodiment of the present invention, or may be a server integrated with the target data feature extraction device, wherein the target data feature extraction device may be implemented in form of hardware or software.

Related technical terms are explained in brief before the technical solutions of the present invention are described.

A recurrent neural network (RNN) is a recurrent neural network that uses sequence data as an input and performs recursion in an evolving direction of a sequence, and in which all nodes (recurrent units) are in a chain connection.

A long short-term memory (LSTM) network is a time recurrent neural network designed exclusively for solving the issue of long-term dependency existing in common RNNs. All RNNs have a chain form of repeating neural network modules. In a standard RNN, such repeating structural module has only one very simple structure, for example, a tanh layer.

A convolutional architecture for fast feature embedding (Caffe) is a deep learning framework with expressiveness, speed and modular thinking. The Caffe has Python and Matlab-related interfaces. The Caffe supports numerous types of deep learning structures, face-oriented image classification and image segmentation, and further supports designs including convolutional neural networks (CNN), region-based convolutional neural networks (R-CNN), LSTM and fully connected neural networks.

Regarding a feature map, data of target data having undergone feature extraction exists in a three-dimensional form in each convolutional layer of a CNN, and may be regarded as multiple two-dimensional images overlaid on one another, wherein each is referred to as a feature map.

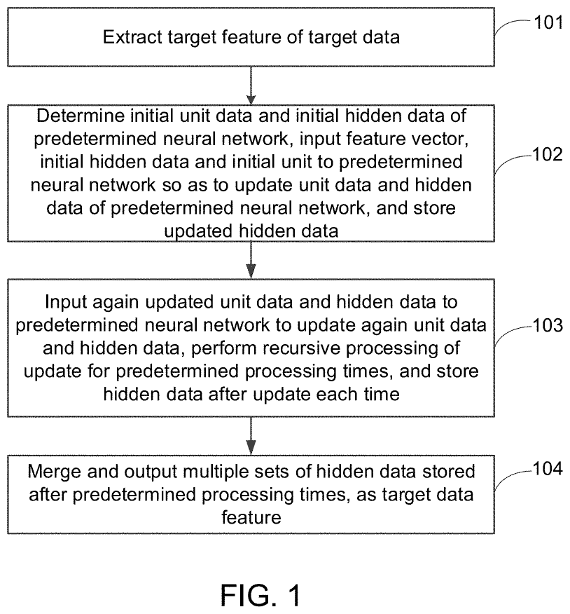

FIG. 1 shows a flowchart of a target data feature extraction method provided according to an embodiment of the present invention. Referring to FIG. 1, the target data feature extraction method includes the following steps.

In step 101, a feature vector of target data is extracted.

The target data above may be target data acquired by an electronic apparatus using a camera, or may be target data downloaded from a network.

In one embodiment, the target data may be inputted to a CNN model, and a feature vector is obtained by performing target identification processing on the target data by the CNN model, wherein the CNN model is a trained model. For example, the CNN model may be formed by a convolutional layer, an activation layer and a batch normalization (BN) layer. Optionally, node parameters in an initial CNN model may be initialized, and a training process may be performed on the initialized initial CNN model by a training set and a test set to obtain a trained CNN model.

It should be noted that, the electronic apparatus may input the target data to the trained CNN model, and perform the target identification processing on the target data by the CNN model to obtain the feature vector. In this embodiment, the target may be a person, an animal or a building in the target data. If the target is a person in the target data, the feature vector may include a feature vector of a different person or the same person in the target data.

In step 102, initial unit data and initial hidden data of a predetermined neural network are determined, the feature vector, the initial unit data and the initial hidden data are inputted to the predetermined neural network for processing, unit data and hidden data of the predetermined neural network are updated, and the updated hidden data are stored.

A current LSTM network based on a Caffe framework includes multiple LSTM units having the same structure, and an output of a previous stage serves as an input of a current stage. For example, x0 serves as an input of the first stage and an output h0 is generated therefrom, and then h0 and x1 serve as an input of the second stage and an output h1 is generated therefrom, and so on. The outputs generated by the individual stages are merged, and outputted as the final result. In order to enable LSTM to adapt to other structures, the LSTM network is improved in this embodiment, and the improved LSTM network includes only one LSTM unit.

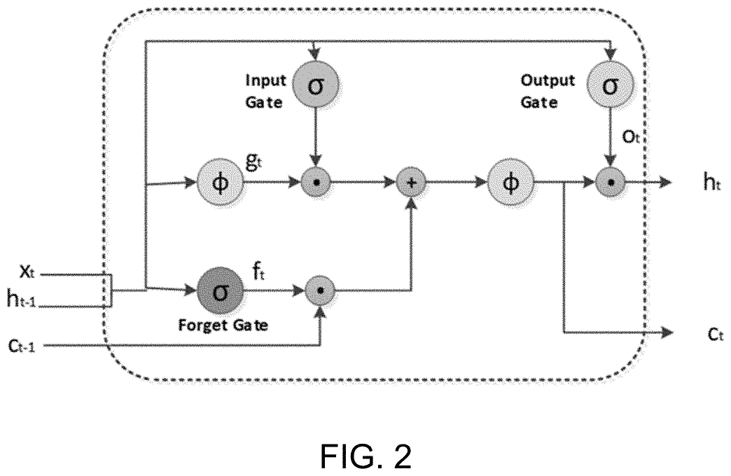

FIG. 2 shows a structural schematic diagram of an LSTM network unit provided according to an embodiment of the present invention. Referring to FIG. 2, the LSTM unit has a total of three inputs, which are respectively data Xt after processing of the CNN of the previous stage, hidden data ht-1 outputted by the LSTM unit of the previous stage, and unit data Ct-1 outputted by the LSTM unit of the previous stage. It should be noted that, if unit data C and the hidden data h are updated by using the LSTM network for the first time, initial unit data C0 and initial hidden data h0 of the LSTM network need to be first determined, for example, setting to 0, respectively. The LSTM unit has two outputs, which are respectively updated unit data Ct and updated hidden data ht. The updated hidden data ht serve as an input to the LSTM unit in the next round of update and serve as a part of the final output, and thus need to be further stored.

For example, when update is performed using the LSTM network for the first time, data X1 inputted by the CNN of the previous stage are first determined, and then the initial data C0 and the initial hidden data h0 of the LSTM network are then determined, for example, setting to 0, respectively. X1, C0 and h0 are then used as inputs to the LSTM unit in the LSTM network, updated unit data C1 and updated hidden data h1 are outputted after the internal operation of the LSTM unit, and the hidden data h1 are stored. In the above, the data X1 are a feature map after processing of the CNN of the previous stage.

It should be noted that, the initial unit data C0 and the initial hidden data h0 are built-in and inputted by the LSTM unit in the LSTM network based on a Caffe framework, that is, generated inside the LSTM unit and invisible to the outside of the LSTM network. In an LSTM network based other structures provided according to an embodiment of the present invention, the initial unit data C0 and the initial hidden data h0 serve as the input of the entire LSTM network. Moreover, outputs of the LSTM network are added, that are, the updated unit data C1 and the updated hidden data h1. Accordingly, the operation of one single LSTM network is complete.

In one embodiment, the framework in the LSTM network based on other frameworks may be a neural network processor (NPU) framework, thereby avoiding the limitation that an LSTM network can only be based on a Caffe framework and enhancing the utilization diversity of the LSTM network.

In step 103, the updated unit data and the updated hidden data are inputted again to the predetermined neural network for processing to update again the unit data and the hidden data, and recursive processing of the update is performed for predetermined processing times, and the hidden data after update each time are stored.

In an embodiment of the present application, since the LSTM network includes only one LSTM unit, the updated unit data C1 and hidden data h1 obtained above need to be again inputted to the LSTM network for processing. More specifically, when the LSTM network is used for update for the second time, there are three sets of input to the LSTM network, that is, data X2 after processing of the CNN of the previous stage, the hidden data h1 outputted by the LSTM unit of the previous stage, and the unit data C1 outputted by the LSTM unit of the previous stage. Thus, the unit data and hidden data above are again updated, updated hidden data C2 and hidden data h2 are obtained, and the hidden data h2 are stored.

In one embodiment, the unit data and the hidden data are updated for multiple times by the LSTM network, and the input values inputted to the LSTM each time include: data Xt after processing of the CNN of the previous stage, hidden data ht-1 outputted by the LSTM unit of the previous stage, and unit data Ct-1 outputted by the LSTM unit of the previous stage, the output is updated hidden data ht and unit data Ct, and the hidden data ht are stored.

For example, assuming that update is performed for 16 times using the LSTM network, hidden data h16 and unit data C16 from update of the last time are obtained, and h1, h2, h3, h16 respectively outputted by update of the 16 times are stored according to such order after storing the hidden data h16.

Further, in the LSTM unit above, the hidden data and the unit data may be updated by means of three control switches; for example, the first switch is in charge of control for continuously storing long-term data c, the second switch is in charge of control for inputting data in real-time to the long-term data c, and the third switch is in charge of control for whether using the long-term data c as the output of the current LSTM unit. In one embodiment, the three switches may be implemented by gates, wherein the gate is substantially a fully connected layer, the input is a vector, and the output is a real-number vector between 0 and 1. The equation of the above is:

g(x)=sigmoid(Wx+b)

In the equation above, “W” is a weighting, and “b” is a bias. More specifically, the output vector of the gate is multiplied by the vector that needs to be controlled. Since the output of the gate is a real-number vector between 0 and 1, when the output is 0, a 0 vector is obtained by multiplying any vector with this output of the gate, and this is equivalent to not allowing passing of anything; when the output is 1, no change is resulted by multiplying any vector with this output, and this is equivalent to allowing passing of everything.

In one embodiment, the three gats may be a forget gate, an input gate and an output gate. More specifically, the forget gate is for determining, in the inputted unit data Ct-1, the unit data Ct preserved up to the current moment, the input gate is for determining the information quantity xt inputted to the LSTM network unit and updating the data Ct of the current LSTM network unit, and the output gate is for determining the unit data Ct and the hidden data ht needing to be outputted by the current LTMS network unit.

In one embodiment, the forget gate, the input gate and the output gate include multiple functions, which are a sigmoid function, a tanh function, an addition function and a multiplication function. More specifically, the forget gate may include a sigmoid function and a multiplication function, the input gate may include a sigmoid function, a tanh function, an addition function and a multiplication function, and the output gate may include a sigmoid function, a tanh function and a multiplication function. It should be noted that, the LSTM network provided in the embodiment is not limited to the Caffe framework, for example, an LTSM network in an NPU structure may be used, and so the operations of the multiple functions above may be implemented by a hardware operation unit created by the NPU.

In step 104, the multiple sets of hidden data stored after the predetermined pressing times are merged, and outputted as a target data feature.

For example, assuming that update is performed for 16 times using the LSTM network, the updated hidden data h16 and unit data C16 of update of the last time are obtained, and the hidden data h16 are stored. Then, the hidden data h1, h2, h3, . . . h16 outputted respectively after the 16 times of update are stored according to such order, and the 16 sets of hidden data are merged and outputted as a target data feature.

In one embodiment, the target data feature may be used for behavior prediction of a person in the target data. Further, the predetermined neural network above, i.e., the LSTM network, may be first trained. For example, training samples are acquired and inputted to the LSTM network to train weightings and bias data of the control gates (the forget gate, input gate and output gate) in the network. A trained LSTM network model is provided for test of test samples, at the same time the LSTM network outputs human training features from data of a training sample set, and the human training features are inputted to a softmax classifier for classification to obtain a training classification result. Then, a test sample set is inputted to the trained LSTM network for test, the LSTM network outputs human test features, and the human test features are input to the softmax classifier for classification to obtain a test classification result. Finally, human behaviors in all target data may be classified according to the training classification result and the test classification result, and all target human behaviors in the target get may be classified according to the classification result.

It should be noted that, the target data includes such as texts, images and sounds, and further limitation is not defined thereto by the present invention.

It is known from the above, the embodiment of the present invention can extract target data features in an LSTM network by means of single deduction, thereby applying in the LSTM network to different structures and enhancing diversity.

An example according to the target data feature extraction method described in the foregoing embodiment of the present invention is further described in detail below.

In this embodiment, a target data feature extraction device is specifically integrated in a terminal device as an example for illustrations.

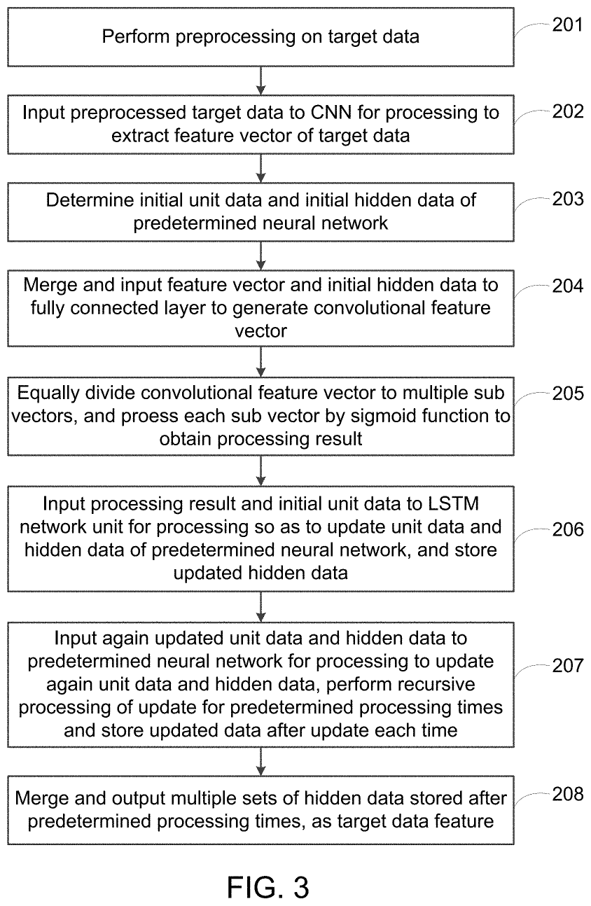

FIG. 3 shows another flowchart of a target data feature extraction method provided according to an embodiment of the present invention. Referring to FIG. 3, the process of the method includes the following steps.

In step 201, preprocessing is performed on target data.

In one embodiment, the target data may be in multiple sets, for example, multiple sets of target data acquired by an electronic apparatus through multiple times of capturing using a camera, or may be multiple sets of target data downloaded from a network.

In one embodiment, before the electronic apparatus processes the target data, the electronic apparatus may adjust the sizes of the multiple sets of target data to target data having a uniform size. The electronic apparatus then performs preprocessing on the target data in the adjusted size. Optionally, the preprocessing may be a process for removing noise signals from the target data, or may be normalization process performed on the target data. In other embodiments, the preprocessing may be an average removal method for a channel.

In step 202, the preprocessed target data are inputted to the CNN for processing so as to extract a feature vector of the target data.

In one embodiment, the target data may be inputted to a CNN model, and a target identification process is performed on the target data by the CNN model to obtain the feature vector, wherein the CNN model is a trained model.

In step 203, initial unit data and initial hidden data of a predetermined neural network are determined.

It should be noted that, the initial unit data and initial hidden data in an LSTM network in a Caffe framework are generated internally by a network, that is, a built-in input. However, the LSTM network of this embodiment is based on another structure and includes only one LSTM unit, wherein the LSTM is provided in a neural network device and may be formed by a hardware circuit. In the LSTM network provided in the embodiment of the present invention, three input values are included—data Xt after processing of the CNN of the previous stage, hidden data ht-1 outputted by the LSTM unit of the previous stage, and unit data Ct-1 outputted by the LSTM unit of the previous stage.

In one embodiment, if unit data C and the hidden data h are updated by using the LSTM network for the first time, initial unit data C0 and initial hidden data h0 of the LSTM network need to be first determined, for example, setting to 0, respectively.

In step 204, the feature vector and the initial hidden data are merged and inputted to a fully connected layer for processing to generate a convolutional feature vector.

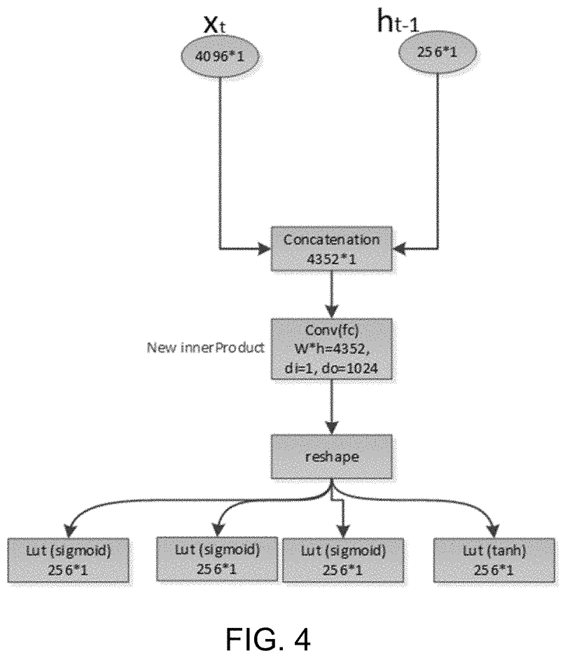

An LSTM network in a Caffe framework usually includes two fully connected layers. Inputs to the two fully connected layers are different, and are respectively the data Xt after processing of the CNN of the previous stage, and the hidden data ht-1 outputted by the LSTM unit of the previous stage. However, the LSTM network based on another framework provided by the present application includes only one fully connected layer, and so the feature vector and the initial hidden data need to be merged in the embodiment of the present application, as shown in FIG. 4. FIG. 4 shows a structural schematic diagram of a fully connected layer provided by an embodiment of the present invention. That is, the data Xt and ht-1 above are merged and inputted to the fully connected layer for processing after the merging, and a convolutional feature vector is generated.

In step 205, the convolutional feature vector is equally divided into multiple sub vectors, and each of the sub vectors is processed by the sigmoid function to obtain a processing result.

Referring to FIG. 4, in one embodiment, the convolutional feature vector outputted by the fully connected layer in the LSTM network may be further equally divided, for example, divided into four equal parts, and each part is then processed by the sigmoid function. In other embodiments, after the dividing equally, each part may be processed by the tanh function.

In step 206, the processing result and the initial unit data are inputted to the LSTM network unit for processing, so as to update the unit data and hidden data of the predetermined neural network, and the updated hidden data are stored.

For example, when update is performed using the LSTM network for the first time, the data X1 inputted to the CNN of the previous stage are first determined, and then the initial data C0 and the initial hidden data h0 of the LSTM network are then determined, for example, setting to 0, respectively. The data X1, C0 and h0 are then used as an input to the LSTM unit in the LSTM network, updated unit data C1 and updated hidden data h1 are outputted after the internal operation of the LSTM unit, and the hidden data h1 are stored. In the above, the data X1 are a feature map after processing of the front-end of the CNN.

In step 207, the updated unit data and hidden data are inputted again to the predetermined neural network for processing so as to update again the unit data and hidden data. Recursive processing of the update is performed for predetermined processing times, and the hidden data after update each time are stored.

Further, by updating the unit data and hidden data for multiple times using the LSTM network, input values inputted to the LSTM network each time include: the data Xt after processing of the CNN of the previous stage, the hidden data ht-1 outputted by the LSTM unit of the previous stage, and the unit data Ct-1 outputted by the LSTM unit of the previous stage, the output includes the updated hidden data ht and unit data Ct, and the hidden data ht are stored. In one embodiment, the LSTM unit includes a forget gate, an input gate and an output gate. The first step in the LSTM unit is to determine what information is to be discarded from the unit data, and such determination is completed by the forget gate. The gate reads the data ht-1 and xt, and outputs a value between 0 and 1 to each numeral in the unit data ct-1, where 1 represents “keep completely” and 0 represents “discard completely”.

The forget gate is for determining, in the inputted unit data Ct-1, the unit data Ct preserved up to the current moment. For example, after processing by the sigmoid function, information ft in the current LSTM unit is obtained by processing the hidden data ht-1 outputted previously by the LSTM unit and the data xt inputted to the current LSTM unit by the sigmoid function, and ft is calculated to determine the part needing to be discarded, wherein the equation for calculating ft is:

ft=sigmoid(Wf*[ht−1,xt]+bf)

In the equation above, “Wf” is the weighting of the information ft in the current LSTM unit, and “bf” is a bias of the information ft in the current LSTM unit.

The input gate is for determining the information quantity xt inputted to the current LSTM network unit, and updating the data Ct in the current LSTM network unit. For example, information “it”, which needs to be updated in the current LSTM unit, is obtained by processing the hidden data ht-1 outputted previously by the LSTM unit and the input xt of the current LSTM unit by the sigmoid function, wherein the equation for calculating the information “it” is:

it=sigmoid(Wi*[ht−1,xt]+bi)

In the equation above, “Wi” is the weighting of the information “it” needing to be updated, and “bi” is the bias of the information “it” needing to be updated.

Then, data of the current LSTM unit are updated to “gt”, “it” and “gt” are processed, accumulated with the output of the forget gate and inputted to the input gate, wherein the equation for calculating “gt” is:

gt=tan h[Wg*ht−1+Wg*xt+bg]

In the equation above, “Wg” is the weighting of “gt”, and “bg” is the bias of “gt”.

The output gate is for determining the unit data Ct and the hidden data ht that need to be outputted by the current LSTM network unit, wherein the equation for calculating Ct and ht is:

Ct=(ft*Ct−1)+(it*gt)

In the equation above, Ct-1 is data of the LSTM unit before update.

Further, information “ot” outputted by the current LSTM unit is first calculated, wherein the equation for calculating “ot” is:

ot=sigmoid[Wo*ht−1+Wo*xt+bo]

In the equation above, “Wo” is the weighting of “ot”, and “bo” is the bias of “ot”. Then, the current hidden data ht of the LSTM unit are calculated according to the information “ot” outputted, wherein the equation for calculating “ht” is:

ht=or*tan h[ct]

In step 208, multiple sets of hidden data stored after the predetermined processing times are merged, and outputted as the target data feature.

For example, assuming that update is performed for 16 times using the LSTM network, the updated hidden data h16 and unit data C16 of update of the last time are obtained, and the hidden data h16 are stored. The hidden data h1, h2, h3, h16 outputted respectively after the 16 times of update are stored according to such order, and the 16 sets of hidden data are merged and outputted as a target data feature.

It is known from the above, the embodiment of the present invention can extract target data features in an LSTM network by means of single deduction, thereby applying in the LSTM network to different structures and enhancing diversity.

To better implement the target data feature extraction method provided according to the embodiment of the present invention, a device based on the target data feature extraction method above is further provided according to an embodiment of the present invention. Significances of the terms used are the same as those used in the target data feature extraction method above, and the implementation details may be referred from the description associated with the method.

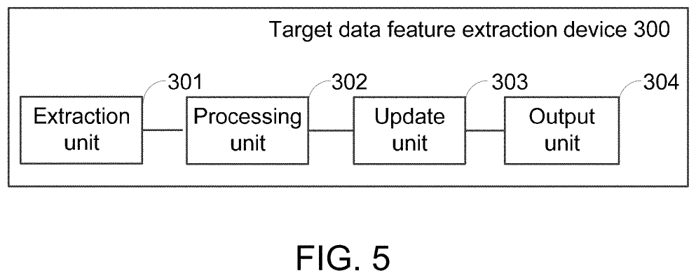

FIG. 5 shows a structural schematic diagram of a target data feature extraction device 300 provided according to an embodiment of the present invention. Referring to FIG. 5, the target data feature extraction device 300 may include an extraction unit 301, a processing unit 302, an update unit 303 and an output unit 304.

The extraction unit 301 is for extracting a feature vector of target data.

In on embodiment, the extraction 301 may input the target data to a CNN model, and a target identification process is performed on the target data by the CNN model to obtain the feature vector, wherein the CNN model may be a trained model.

The processing unit 302 is for determining initial unit data and initial hidden data of a predetermined neural network, and inputting the feature vector, the initial unit data and the initial hidden data to the predetermined neural network for processing so as to update unit data and hidden data of the predetermined neural network, and storing the updated hidden data.

In one embodiment, the predetermined neural network may be an LSTM network, and only one LSTM unit and a fully connected layer are included in the LSTM network.

For example, when update is performed using the LSTM network for the first time, the processing unit 302 first determines data X1 inputted by the CNN of the previous stage, and then determines the initial data C0 and the initial hidden data h0 of the LSTM network, for example, setting to 0, respectively. The processing unit 302 then uses X1, C0 and h0 as an input to the LSTM unit in the LSTM network, outputs updated unit data C1 and updated hidden data h1 after the internal operation of the LSTM unit, and stores the hidden data h1.

It should be noted that, the initial unit data C0 and the initial hidden data h0 are built-in and inputted by the LSTM unit in the LSTM network in a Caffe framework, that is, generated inside the LSTM unit and invisible to the outside of the LSTM network. In an LSTM network of another structure provided according to an embodiment of the present invention, the initial unit data C0 and the initial hidden data h0 serve as the input of the entire LSTM network. Moreover, an output of the LSTM network is added, that is, the updated unit data C1 and the updated hidden data h1. Accordingly, the operation of one single LSTM network is complete.

The update unit 303 is for inputting again the updated unit data and hidden data to the predetermined neural network so as to update again the unit data and the hidden data, recursive processing of the update is performed for predetermined processing times, and the hidden data after update each time are stored.

In an embodiment of the present application, since the LSTM network includes only one LSTM unit, the updated unit data C1 and hidden data h1 obtained above need to be inputted again to the LSTM network for processing.

In one embodiment, the update unit 303 updates the unit data and the hidden data by the LSTM network unit, input values inputted to the LSTM network each time include the data Xt after processing of the CNN of the previous stage, the hidden data ht-1 outputted by the LSTM unit of the previous stage, and the unit data Ct-1 outputted by the LSTM unit of the previous stage, the output includes the updated hidden data ht and unit data Ct, and the hidden data ht are stored.

The output unit 304 is for merging and outputting the multiple sets of hidden data stored after the predetermined processing times, as a target data feature.

For example, assuming that update is performed for 16 times using the LSTM network, hidden data h16 and unit data C16 from update of the last time are obtained, and h1, h2, h3, h16 respectively outputted by update of the 16 times are stored according to such order after storing the hidden data h16.

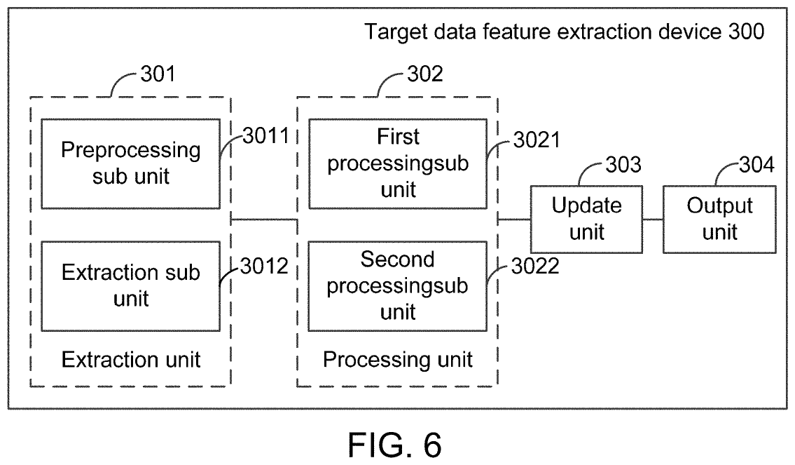

FIG. 6 shows another structural schematic diagram of the target data feature extraction 300 provided according to an embodiment of the present invention. In one embodiment, referring to FIG. 6, the extraction unit 301 in the target data feature extraction device 300 may include: a preprocessing unit 3011, for performing preprocessing on the target data; and an extraction sub unit 3012, for inputting the preprocessed target data to the CNN for processing so as to extract the feature vector of the target data.

In one embodiment, the processing unit 302 may include: a first processing sub unit 3021, for inputting the merged feature vector and initial hidden data to the fully connected layer for processing to obtain a processing result; and a second processing sub unit 3022, for inputting the processing result and the initial unit data to the LSTM network unit for processing.

The target data feature extraction method and device provided according to the embodiments of the present invention are described in detail as above. The principle and implementation details of the present application are described by way of specific examples in the literature, and the illustrations given in the embodiments provide assistance to better understand the method and core concepts of the present application. Variations may be made to specific embodiments and application scopes by a person skilled in the art according to the concept of the present application. In conclusion, the disclosure of the detailed description is not to be construed as limitations to the present application.

What is claimed is:

1. A target data feature extraction method, comprising:
extracting a feature vector of target data;
determining initial unit data and initial hidden data of a predetermined neural network, inputting the feature vector, the initial unit data and the initial hidden data to the predetermined neural network for processing so as to update unit data and hidden data of the predetermined neural network, and storing updated hidden data;
inputting again the updated unit data and the hidden data to the predetermined neural network for processing so as to update again the unit data and the hidden data, performing recursive processing of the update for predetermined processing times, and storing hidden data after the update each time; and
merging and outputting a plurality of sets of hidden data stored after the predetermined processing times, as a target data feature.

2. The target data feature extraction method according to claim 1, wherein the predetermined neural network comprises a fully connected layer and a long short-term memory (LSTM) network unit; the step of inputting the feature vector, the initial unit data and the initial hidden data to the predetermined neural network comprises:
merging and inputting the feature vector and the initial hidden data to the fully connected layer to obtain a fully connected layer processing result; and
inputting the fully connected layer processing result and the initial unit data to the LSTM network unit for processing.

3. The target data feature extraction method according to claim 2, wherein the step of merging and inputting the feature vector and the initial hidden data to the fully connected layer to obtain the fully connected layer processing result comprises:
merging and inputting the feature vector and the initial hidden data to the fully connected layer for processing to generate a convolutional feature vector; and
equally dividing the convolutional feature vector into a plurality of sub vectors, and processing each of the sub vectors by a sigmoid function to obtain a processing result.

4. The target data feature extraction method according to claim 1, applied to a neural network device, the neural network device comprising a long short-term memory (LSTM) network unit, the method using the LSTM network unit to perform the recursive processing on the unit data and the hidden data for the predetermined processing times.

5. The target data feature extraction method according to claim 2, wherein the LSTM network unit comprises a forget gate, an input gate and an output gate sequentially connected; the forget gate is for determining, in the inputted unit data, the unit data preserved up to the current moment; the input gate is for determining a quantity of sets of information inputted to a current LSTM network unit, and updating data of the current LSTM network unit; and the output gate is for determining the unit data and the hidden data needing to be outputted by the current LSTM network unit.

6. The target data feature extraction method according to claim 5, wherein the forget gate, the input gate and the output gate comprise a plurality of functions, which are a sigmoid function, a tanh function, an addition function and a multiplication function, and the plurality of functions are used to perform operations by operators in a neural network processor.

7. The target data feature extraction method according to claim 1, wherein the step of extracting the target data comprises:
performing preprocessing the target data; and
inputting the preprocessed target data to the predetermined neural network for processing to extract the feature vector of the target data.

8. A target data feature extraction device, comprising:
an extraction unit, for extracting a feature vector of target data;
a processing unit, for determining initial unit data and initial hidden data of a predetermined neural network, inputting the feature vector, the initial unit data and the initial hidden data to the predetermined neural network for processing so as to update unit data and hidden data of the predetermined neural network, and storing updated hidden data;
an update unit, for inputting again the updated unit data and the hidden data to the predetermined neural network for processing so as to update again the unit data and the hidden data, performing recursive processing of the update for predetermined processing times, and storing hidden data after the update each time; and
an output unit, merging and outputting a plurality of sets of hidden data stored after the predetermined processing times, as a target data feature.

9. The target data feature extraction device according to claim 8, wherein the processing unit comprises:
a first processing sub unit, merging and inputting the feature vector and the initial hidden data to the fully connected layer for processing to generate a processing result; and
a second processing sub unit, inputting the processing result and the initial unit data to the LSTM network unit for processing.

10. The target data feature extraction device according to claim 8, wherein the extraction unit comprises:
a preprocessing sub unit, for performing preprocessing of the target data; and
an extraction sub unit, for inputting the preprocessed target data to a convolutional neural network for processing to extract the feature vector of the target data.
